(19) United States
(12) Patent Application Publication
(10) Pub. No.: US 2026/0040270 A1
(43) Pub. Date: Feb. 5, 2026

(54) POSITIONING AND SENSING METHOD BASED ON INTERNET OF THINGS DEVICE, NETWORK ELEMENT, SYSTEM, AND ELECTRONIC DEVICE

(71) Applicant: Beijing Xiaomi Mobile Software Co., Ltd., Beijing (CN)

(72) Inventor: Jinhua WU, Beijing (CN)

(21) Appl. No.: 18/994,474

(22) PCT Filed: Jul. 21, 2022
(86) PCT No.: PCT/CN2022/107207

§ 371 Date: Jan. 14, 2025

(51) Int. Cl. H04W 64/00

(52) U.S. Cl. CPC H04W 64/006

(57) ABSTRACT

A positioning and sensing method for an internet of things (IoT) device, includes: sending, by an application function (AF), a subscription location request to a network exposure function (NEF), wherein the subscription location request is configured to request to subscribe to a location of an IoT device; wherein the subscription location request includes identifier information of the IoT device and reference sensing information, and the reference sensing information is configured to indicate physical information of a reference object collocated with the IoT device.

### CROSS REFERENCE TO RELATED APPLICATIONS

This application is a US National Phase of International Application No. PCT/CN2022/107207, filed on Jul. 21, 2022, the entire contents of which are incorporated herein by reference.

### TECHNICAL FIELD

The present disclosure relates to the field of communication technologies and in particular to a positioning and sensing method for an internet of things (IoT) device, a network element, a system and an electronic device.

### BACKGROUND

Related arts support location service function to allow the development of new location-based services. A current location of a terminal of a user can be identified and reported in a standardized format (e.g., geographic coordinates), and the location can be made available to subscribers, network operators, service providers, value-added service providers and others.

In a use case, the user has an internet of things (IoT) device for location for tracking the user's belonging. However, there may be some unreasonable use cases, for example, the IoT device are used to track other objects (i.e., objects other than the user) that do not allow such tracking. There is currently no solution to the above problem in the mobile network.

### SUMMARY

According to a first aspect of the present disclosure, there is provided a positioning and sensing method for an IoT device, performed by an application function (AF) and including:
sending a subscription location request to a network exposure function (NEF), where the subscription location request is configured to request to subscribe to a location of an IoT device;
where the subscription location request includes identifier information of the IoT device and reference sensing information, and the reference sensing information is configured to indicate physical information of a reference object collocated with the IoT device.

According to a second aspect of the present disclosure, there is provided a positioning and sensing method for an IoT device, performed by a network exposure function (NEF) and including:
receiving a subscription location request sent by an application function (AF), where the subscription location request is configured to indicate that a location of an IoT device is subscribed to, the subscription location request includes identifier information of the IoT device and reference sensing information, and the reference sensing information is configured to indicate physical information of a reference object collocated with the IoT device;
authorizing the AF to use a location service (LCS); and
sending a providing location request to a gateway mobile location center (GMLC), where the providing location request is configured to request to obtain the location of the IoT device, and the providing location request includes the identifier information of the IoT device and the reference sensing information.

According to a third aspect of the present disclosure, there is provided a positioning and sensing method for an IoT device, performed by a gateway mobile location center (GMLC) and including:
receiving a providing location request sent by a network exposure function (NEF), where the providing location request is configured to request to obtain a location of an IoT device, the providing location request includes identifier information of the IoT device and reference sensing information, and the reference sensing information is configured to indicate physical information of a reference object collocated with the IoT device; and
sending a positioning sensing message request to an access and mobility management function (AMF), where the positioning sensing message request is configured to request to obtain the location of the IoT device and actual sensing information, the actual sensing information is configured to indicate physical information of an actual object collocated with the IoT device, and the positioning sensing message request includes the identifier information of the IoT device.

According to a fourth aspect of the present disclosure, there is provided a positioning and sensing method for an IoT device, performed by an access and mobility management function (AMF) and including:
receiving a positioning sensing message request, where the positioning sensing message request is configured to request to obtain a location of an IoT device and actual sensing information, the actual sensing information is configured to indicate physical information of an actual object collocated with the IoT device, and the positioning sensing message request includes identifier information of the IoT device; and
sending a determining location request to a location management function (LMF), where the determining location request is configured to request to obtain the location of the IoT device and the actual sensing information, and the determining location request includes the identifier information of the IoT device.

According to a fifth aspect of the present disclosure, there is provided a positioning and sensing method for an IoT device, performed by a location management function (LMF) and including:
receiving a determining location request sent by an access and mobility management function (AMF), where the determining location request is configured to request to obtain a location of an IoT device and actual sensing information, the actual sensing information is configured to indicate physical information of an actual object collocated with the IoT device, and the determining location request includes identifier information of the IoT device; and
sending an NIN2 message transfer request to the AMF, where the NIN2 message transfer request includes the identifier information of the IoT device and a network positioning sensing message to be carried with the location of the IoT device and the actual sensing information.

According to a sixth aspect of the present disclosure, there is provided a positioning and sensing method for an IoT device, performed by a next generation radio access network (NG-RAN) node and including:
receiving a first N2 transport message sent by an access and mobility management function (AMF), where the first N2 transport message includes identifier information of an IoT device and a network positioning sensing message to be carried with a location of the IoT device and actual sensing information;
obtaining the location of the IoT device and the actual sensing information, where the actual sensing information is configured to indicate physical information of an actual object collocated with the IoT device; and
sending a second N2 transport message to the AMF, where the second N2 transport message includes a network positioning sensing message carrying the location of the IoT device and the actual sensing information.

According to a seventh aspect of the present disclosure, there is provided a positioning and sensing method for an IoT device, including:
sending, by an application function (AF), a subscription location request, where the subscription location request is configured to request to subscribe to a location of an IoT device, the subscription location request includes identifier information of the IoT device and reference sensing information, and the reference sensing information is configured to indicate physical information of a reference object collocated with the IoT device;
receiving, by the NEF, the subscription location request, authorizing, by the NEF, the AF to use a location service (LCS), and sending, by the NEF, a providing location request to a gateway mobile location center (GMLC), where the providing location request is configured to request to obtain the location of the IoT device, and the providing location request includes the identifier information of the IoT device and the reference sensing information;
receiving, by the GMLC, the providing location request, and sending, by the GMLC, a positioning sensing message request to an access and mobility management function (AMF), where the positioning sensing message request is configured to request to obtain the location of the IoT device and actual sensing information;
receiving, by the AMF, the positioning sensing message request, sending a determining location request to a location management function (LMF), where the determining location request is configured to request to obtain the location of the IoT device and the actual sensing information, and the determining location request includes the identifier information of the IoT device;
receiving, by the LMF, the determining location request, and sending, by the LMF, a NIN2 message transfer request to the AMF, where the NIN2 message transfer request is configured to request to obtain the location of the IoT device and the actual sensing information, and the NIN2 message transfer request includes the identifier information of the IoT device and a network positioning sensing message to be carried with the location of the IoT device and the actual sensing information;
receiving, by the AMF, the NIN2 message transfer request, and sending, by the AMF, a first N2 transport message to a next generation radio access network (NG-RAN) node of the IoT device, where the first N2 transport message is configured to request to obtain the location of the IoT device and the actual sensing information, and the first N2 transport message includes the identifier information of the IoT device and the network positioning sensing message to be carried with the location of the IoT device and the actual sensing information;
receiving, by the NG-RAN node, the first N2 transport message, obtaining, by the NG-RAN node, the location of the IoT device and the actual sensing information, and sending, by the NG-RAN node, a second N2 transport message to the AMF, where the second N2 transport message includes a network positioning sensing message carrying the location of the IoT device and the actual sensing information;
receiving, by the AMF, the second N2 transport message, and sending, by the AMF, an N2 message notification to the LMF, where the N2 message notification includes the network positioning sensing message carrying the location of the IoT device and the actual sensing information.
receiving, by the LMF, the N2 message notification, and sending, by the LMF, a determining location response to the AMF, where the determining location response includes the location of the IoT device and the actual sensing information;
receiving, by the AMF, the determining location response sent by LMF, and sending, by the AMF, a positioning sensing information response to the GMLC, where the positioning sensing information response includes the location of the IoT device and the actual sensing information;
receiving, by the GMLC, the positioning sensing information response, obtaining, by the GMLC, a comparison result between the actual sensing information and the reference sensing information, and sending, by the GMLC based on the comparison result, a providing location response to the NEF; where in response to the comparison result being consistent, the providing location response includes the location of the IoT device; in response to the comparison result being inconsistent, the providing location response includes a subscription failure message, and the subscription failure message is configured to indicate that subscribing to the location of the IoT device is unsuccessful;
receiving, by the NEF, a providing location response; and in response to determining that the providing location response includes the location of the IoT device, sending, by the NEF, a location notification to the AF, where the location notification includes the location of the IoT device; in response to determining that the positioning location response includes a subscription failure message, sending, by the NEF, an exposure subscription response to the AF, where the exposure subscription response includes the subscription failure message; and
obtaining, by the AF, the location notification or the exposure subscription response.

According to an eighth aspect of the present disclosure, there is provided a positioning and sensing system for an IoT device, including at least one of:
an application function (AF), configured to perform the method according to the first aspect;
a network exposure function (NEF), configured to perform the method according to the second aspect;
a gateway mobile location center (GMLC), configured to perform the method according to the third aspect;
an access and mobility management function (AMF), configured to perform the method according to the fourth aspect;
a location management function (LMF), configured to perform the method according to the fifth aspect; or
a next generation radio access network (NG-RAN) node, configured to perform the method according to the sixth aspect.

According to a ninth aspect of the embodiments of the present disclosure, there is provided an electronic device, including: a processor; and a memory storing computer programs executable by the processor; where the computer programs, when executed by the processor, cause the processor to perform the positioning and sensing method for the IoT device according to any one of the first to sixth aspects.

According to another aspect of the embodiments of the present disclosure, there is provided a computer-readable storage medium, storing computer programs thereon, where the computer programs, when executed by a processor, cause the processor to perform the positioning and sensing method for the IoT device according to any one of the first to sixth aspects.

### BRIEF DESCRIPTION OF THE DRAWINGS

The following briefly introduces the accompanying drawings of the present disclosure.

FIG. 1 is a flowchart illustrating a positioning and sensing method for an IoT device according to an embodiment of the present disclosure.

FIG. 2 is a flowchart illustrating a positioning and sensing method for an IoT device according to another embodiment of the present disclosure.

FIG. 3 is a flowchart illustrating a positioning and sensing method for an IoT device according to yet another embodiment of the present disclosure.

FIG. 4 is a flowchart illustrating a positioning and sensing method for an IoT device according to still another embodiment of the present disclosure.

FIG. 5 is a flowchart illustrating a positioning and sensing method for an IoT device according to still another embodiment of the present disclosure.

FIG. 6 is a flowchart illustrating a positioning and sensing method for an IoT device according to still another embodiment of the present disclosure.

FIG. 7 is a flowchart illustrating a positioning and sensing method for an IoT device according to still another embodiment of the present disclosure.

FIG. 8 is a structural schematic diagram illustrating an application function (AF) according to an embodiment of the present disclosure.

FIG. 9 is a structural schematic diagram illustrating a network exposure function (NEF) according to an embodiment of the present disclosure.

FIG. 10 is a structural schematic diagram illustrating a gateway mobile location center (GMLC) according to an embodiment of the present disclosure.

FIG. 11 is a structural schematic diagram illustrating an access and mobility management function (AMF) according to an embodiment of the present disclosure.

FIG. 12 is a structural schematic diagram illustrating a location management function (LMF) according to an embodiment of the present disclosure.

FIG. 13 is a structural schematic diagram illustrating a next generation radio access network (NG-RAN) node according to an embodiment of the present disclosure.

FIG. 14 is a structural schematic diagram illustrating a positioning and sensing system for an IoT device according to an embodiment of the present disclosure.

FIG. 15 is a structural schematic diagram illustrating an electronic device according to an embodiment of the present disclosure.

### DETAILED DESCRIPTION OF THE EMBODIMENTS

Embodiments of the present disclosure are described below in conjunction with the accompanying drawings in the present disclosure. It will be understood that the embodiments described below in conjunction with the accompanying drawings are exemplary descriptions for explaining the technical solutions of the embodiments of the present disclosure, and do not constitute limitations on the technical solutions of the embodiments of the present disclosure.

It will be understood by those skilled in the art that the singular forms “a”, “an”, and “the” used herein may also include plural forms unless otherwise stated. It will be further understood that the terms “include” and “include” as used in the embodiments of the present disclosure mean that the corresponding features may be realized as the presented features, information, data, steps, operations, elements and/or components, but do not exclude the realization of other features, information, data, operations, elements, components, and/or combinations thereof as supported in the art. It will be understood that when we refer to an element being “connected” or “coupled” to another element, the element may be directly connected or coupled to another element, or it may refer to the connection between the one element and the other element being established through an intermediate element. Furthermore, the term “connect” or “couple” as used herein may include wirelessly connected or wirelessly coupled. The term “and/or” as used herein is indicative of at least one of the items defined by the term, e.g., “A and/or B” may be realized as “A”, “B”, or “A and B”.

Example use cases for investigating a 5th generation mobile communication technology (5G) to provide a communication-assisted sensing service (e.g., a location service) include the followings.

Environment Real-time monitoring: Using wireless signals to reconstruct the environment map to further improve positioning accuracy and enable environment related applications, such as realizing an array of real-time monitoring related applications including dynamic 3D map for driving assistance, pedestrian flow statistics, intrusion detection, traffic detection and etc.

Autonomous vehicles/UAV: Autonomous vehicles/UAV applications have some common functional requirements. For example, Autonomous vehicles/UAV shall support Detect and Avoid (DAA) to avoid obstacles. Meanwhile, Autonomous vehicles/UAV shall have the capability to monitor path information, like selecting routes, complying with traffic regulations.

Air pollution monitoring: The quality of the received wireless signal displays different attenuation characteristics with changes in air humidity, air particulate matter (PM) concentration, carrier frequency and, etc., which can be used for weather or air quality detection.

Indoor Health Care and Intrusion Detection. Respiration rate estimation, breathing depth estimation, apnoea detection, elders' vital sign monitoring and indoor intrusion detection can be realized.

Sensing of wireless communication channels and environment could further improve the performance of communication systems. Some examples of sensing assisted communication scenarios include the followings.

Sensing User Equipment's (UE's) location and channel environment of to narrow the beam sweeping range and shorten the beam training time.

Sensing UE's location, velocity, motion trajectory, and channel environment for beam prediction, and reducing the overhead of beam measurement and the delay of beam tracking.

Sensing UE's property and channel environment to improve the performance of channel estimation.

To make the object, technical solution and advantages of the present disclosure clearer, the embodiments of the present disclosure will be described below in detail in combination with accompanying drawings.

To solve the problems in the related arts, the embodiments of the present disclosure provide a positioning and sensing method for an IoT device, a network element, a system and an electronic device.

The technical solutions of the embodiments of the present disclosure and the technical effects resulting from the technical solutions of the present disclosure are described below by describing exemplary embodiments. It will be noted that the embodiments may be referred to, borrowed from, or combined with each other, and the same terms, similar features, and similar implementation steps in the different embodiments will not be described repeatedly.

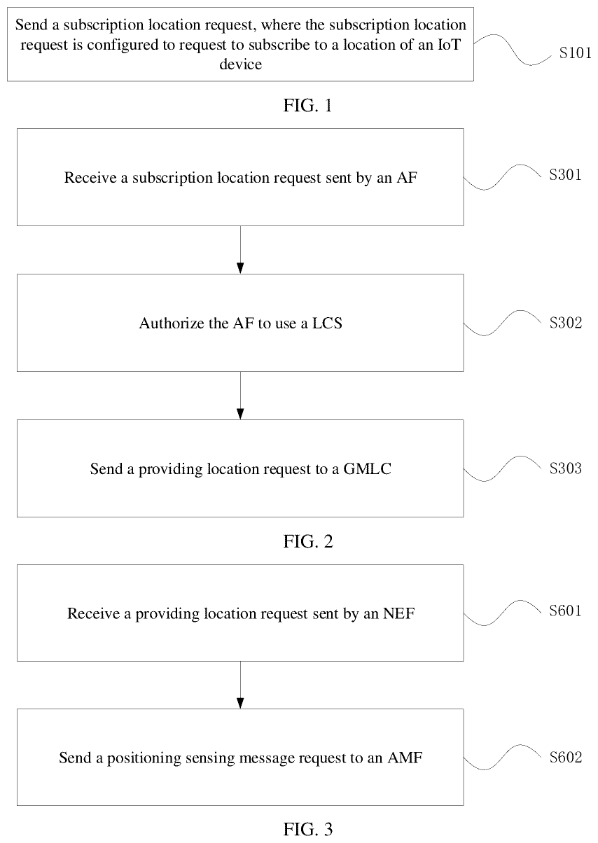

An embodiment of the present disclosure provides a positioning and sensing method for an IoT device, which is performed by an application function (AF), and as shown in FIG. 1, the method includes the following step S101.

At step S101, a subscription location request is sent to a network exposure function (NEF), where the subscription location request is configured to request to subscribe to a location of an IoT device.

It will be understood that the AF and the NEF are both network elements. The AF is similar to an application server, which interacts with the control plane network function in the core network and provides one or more services. The AF of the present disclosure may send a subscription location request when triggered to provide a service related to the location of the IoT device.

In some embodiments, the location of the IoT device may be geographic coordinates, indoor spatial coordinates, and the like.

In some embodiments, the subscription location request may be a Nnef_EventExposure_Subscribe request.

In some embodiments, the subscription location request includes identifier information of the IoT device and reference sensing information, and the reference sensing information is configured to indicate physical information of a reference object collocated with the IoT device.

The identifier information of the IoT device is configured to identify the IoT device. For example, the identifier information of the IoT device is a generic public subscription identifier (GPSI), a subscription permanent identifier (SUPI), and other identifiers that can be used for localization.

In some embodiments, the identifier information of the IoT device is at least one of the GPSI and the SUPI.

The IoT device of the embodiments of the present disclosure may be a hardware device for a smart home, which may include a mobile terminal, a household appliance, a sensor device and the like. For example, the IoT device can be a smart phone, a smart speaker, a smart refrigerator, a smart TV, a smart light, a smart plug, an air purifier, a humidifier, a smart range hood, a smart desk lamp, a smart door lock, a smart patch panel, a smart induction cooker, a smart camera and so on. The IoT device can also be a smoke sensor, a human body sensor, a temperature sensor, a humidity sensor, a door and window sensor, an air quality sensor, etc.

The collocate relationship between the IoT device and the reference object in the embodiment of the present disclosure may be that the IoT device is located on the surface of the reference object, or the whole IoT device is located inside the reference object, or a part of the IoT device is located inside the reference object.

By storing the reference sensing information in the AF in advance, the present disclosure is equivalent to establishing the corresponding relationship between the IoT device and the reference object, that is, providing the location of the IoT device will not be regarded as unreasonably providing the location of the reference object.

In some embodiments, when the IoT device accesses the core network after updating the collocated reference object each time, it is required to report the updated permission information as well as the updated reference sensing information to the AF, and it is understood that the updated reference sensing information is configured to indicate the physical information of the updated reference object collocated with the IoT device.

The updated permission information is configured to indicate that the knowledge and consent of the owner of the updated reference object has been obtained. For example, when the IoT device is an on-board locator, and a vehicle data recorder is first installed in a vehicle, the updated permission information that the IoT device needs to report to the AF is configured to indicate that the knowledge and consent of the owner of the vehicle has been obtained, and the reference sensing information may be configured to indicate the physical information of the vehicle, such as a shape, a size, and so on. If subsequently the vehicle data recorder is reinstalled in another vehicle, the IoT device needs to report new updated permission information to the AF. The new updated permission information is configured to indicate to obtain the knowledge and consent of the owner of another vehicle.

The reference sensing information is included in the subscription location request to obtain the actual sensing information (to indicate the physical information of the actual object collocated with the IoT device) in the subsequent period, and by comparing the actual sensing information with the reference sensing information for consistency, it is determined whether the reference object and the actual object are the same object, and then it is determined whether the location of the IoT device can be provided to the AF. The embodiments of the present disclosure may effectively avoid the defect in the prior art caused by the inability to effectively determine whether the location of an actual object collocated with the IoT device is unreasonably provided when the location of the IoT device is provided due to the fact that only the identifier information of the IoT device is provided at the time of requesting a subscription to the IoT device.

It will be understood that the wording “consistent” in the embodiments of the present disclosure may refer to complete consistency, or it may also mean that the similarity exceeds a preset threshold value, it is considered to be consistent, and the embodiments of the present disclosure do not make any specific limitations on the specific size of the threshold value.

In some embodiments, the physical information of the embodiments of the present disclosure may be at least one of a shape or a size.

In some embodiments, the method of determining the sensing information is theoretically based:

During short-range wireless communication, wireless signals emitted by a transmitter typically do not follow a linear path to reach a receiver. The wireless signals received by the receiver are formed by reflection, diffraction, and scattering by various objects in the environment. For example, in an indoor scenario, the wireless signal received by the receiver is a superposition of multiple signals formed by reflection, diffraction, and scattering from furniture, human bodies, and other obstacles. This phenomenon is called multipath effect. Specifically, in the process of short-range wireless communication, objects in the physical space affect the transmission of wireless signals, objects in the environment (e.g., furniture, walls) can “modulate” the wireless signals, making the wireless signals become periodic or time-varying signals. The sensing information of the objects in the environment can be obtained by analyzing the periodic or time-varying signals.

In the positioning and sensing method for the IoT device, the subscription location request sent to the NEF includes not only the identifier information of the IoT device, but also the reference sensing information. The reference sensing information is configured to indicate the physical information of the reference object collocated with the IoT device, which is equivalent to establishing the correspondence between the IoT device and the reference object. Subsequently, when obtaining the location of the IoT device, it will be determined whether the reference object and the actual object are the same by comparing whether the actual sensing information is identical to the reference sensing information, and thus determine whether the location of the IoT device can be provided to the AF. The embodiments of the present disclosure may effectively avoid the defect in the prior art caused by the inability to effectively determine whether the location of an actual object collocated with the IoT device is unreasonably provided when the location of the IoT device is provided due to the fact that only the identifier information of the IoT device is provided at the time of requesting a subscription to the IoT device, so as to ensure that the location information of the IoT device is not misused (it will be understood that when the actual sensing information is inconsistent with the reference sensing information, the location information of the IoT device is misused).

Based on the above-mentioned embodiments, in an embodiment, the positioning and sensing method for an internet of things (IoT) device performed by an application function (AF) further includes the following step S201.

At step S201, a location notification or an exposure subscription response sent by the NEF is obtained.

In some embodiments, when it is determined that the reference sensing information is consistent with the actual sensing information, it indicates that the actual object is the reference object, i.e., the object that is collocated with the IoT device has not changed, and thus providing the location of the IoT device to the AF is a reasonable provision of the location of the actual object that is collocated with the IoT device, i.e., the AF can obtain the location notification. The location notification can include the location of the IoT device.

Accordingly, when it is determined that the reference sensing information is inconsistent with the actual sensing information, it indicates that the sensed actual object is not the reference object, and the object collocated with the IoT device has changed, and thus providing the location of the IoT device to the AF is a unreasonable provision of the location of the actual object that is collocated with the IoT device, and the AF can obtain the an exposure subscription response. the exposure subscription response includes a subscription failure message, and the subscription failure message is configured to indicate that subscribing to the location of the IoT device is unsuccessful.

In some embodiments, the location notification may be a Nnef EventExposure Notify message.

In some embodiments, the exposure subscription response is an Nnef EventExposure Subscribe message.

In some embodiments, after the AF obtains the exposure subscription response, the service related to the location of the IoT device will be stopped because the AF does not obtain the location of the IoT device.

In some embodiments, the AF, after obtaining the location notification, will start the service related to the location of the IoT device because the AF obtains the location of the IoT device.

It will be understood by those skilled in the art that step S201 may be performed either alone, or in combination with step S101, or in combination with the steps of any of other embodiments of the present disclosure.

The subscription failure message includes at least one of:
identifier information for indicating that subscribing to the location of the IoT device is unsuccessful; or
a reason for unsuccessfully subscribing to the location of the IoT device.

The identifier information, when indicating a failure to subscribe to the location of the IoT device, may record a message of “refusal to provide the location of the IoT device” or a message of “failure to provide the location of the IoT device” without specific limitation of the present disclosure.

The reason for the failure to subscribe to the location of the IoT device may be that there is a risk that the location of the IoT device is unreasonably used, or that there is an abnormal change in the object collocated with the IoT device, and so on, and the present disclosure is not specifically limited.

An embodiment of the present disclosure provides a positioning and sensing method for an IoT device, which is performed by a network exposure function (NEF), and as shown in FIG. 2, the method includes the following steps S301 to S303.

At step S301, a subscription location request sent by the AF is received.

At step S302, the AF is authorized to use a location service (LCS).

At step S303, a providing location request is sent to a gateway mobile location center (GMLC). It will be understood that the GMLC is a network element.

It will be understood that if the NEF refuses to authorize the AF to use the LCS service, the NEF will not send the providing location request to the GMLC, resulting in the termination of providing and sensing process of the IoT device.

In the embodiments of the present disclosure, the providing location request is configured to request to obtain the location of the IoT device, and the providing location request includes the identifier information of the IoT device and the reference sensing information. The identifier information of the IoT device and the reference sensing information are sent to the GMLC such that the GMLC further obtains the actual sensing information, compares the actual sensing information with the reference sensing information, and determines whether or not to provide the location of the IoT device to the AF based on the comparison result. It ensures that the location information of IoT devices is not misused.

In some embodiments, the providing location request may be a Ngmlc_Location_ProvideLocation_Request.

The subscription location request, the identifier information of the IoT device, and the reference sensing information of the embodiment of the present disclosure may refer to the embodiment corresponding to step S101, and will not be repeated herein.

In an embodiment, a positioning and sensing method for an internet of things (IoT) device performed by the NEF includes the following step S401.

At step S401, a providing location response sent by the GMLC is received, it is determined that the providing location response includes the location of the IoT device, and a location notification to the AF is sent, where the location notification includes the location of the IoT device.

In some embodiments, the providing location response may be a Ngmlc_Location_ProvideLocation Response message.

In some embodiments, the location notification may be a Nnef EventExposure Notify message.

In an embodiment, the positioning and sensing method for the internet of things (IoT) device performed by the NEF includes the following step S501.

At step S501, a providing location response sent by the GMLC is received, and it is determined that the positioning location response includes a subscription failure message, where the subscription failure message is configured to indicate that subscribing to the location of the IoT device is unsuccessful; and sending an exposure subscription response to the AF, where the exposure subscription response includes the subscription failure message.

In some embodiments, the providing location response may be a Ngmlc_Location_ProvideLocation Response message.

In some embodiment, the subscription failure message includes at least one of:
identifier information for indicating that subscribing to the location of the IoT device is unsuccessful; or
a reason for unsuccessfully subscribing to the location of the IoT device.

The subscription failure message may refer to the embodiment corresponding to step S201, and the embodiments of the present disclosure will not be repeated.

In some embodiments, the exposure subscription response may be an Nnef EventExposure Subscribe message.

An embodiment of the present disclosure provides a positioning and sensing method for an IoT device, which is performed by a gateway mobile location center (GMLC), and as shown in FIG. 3, the method includes the following steps S601 to S602.

At step S601, a positioning request sent by the network open function NEF is received.

At step S602, a location-aware message request is sent to an access and mobility management function (AMF).

The providing location request is configured to request to obtain a location of an IoT device, the providing location request includes identifier information of the IoT device and reference sensing information, and the reference sensing information is configured to indicate physical information of a reference object collocated with the IoT device. It will be understood that the AMF is a network element.

The positioning sensing message request is configured to request to obtain a location of an IoT device and actual sensing information, the actual sensing information is configured to indicate physical information of an actual object collocated with the IoT device, and the positioning sensing message request includes identifier information of the IoT device.

In some embodiments, the providing location request may be a Ngmlc_Location_ProvideLocation_Request.

In some embodiments, the positioning sensing message request may be a Namf_Location_ProvidePositioningSensingInfo Requeset message.

The identifier information of the IoT device, the reference sensing information, and the actual sensing information of the embodiment of the present disclosure may refer to the embodiment corresponding to step S101, and will not be repeated herein.

According to the positioning and sensing method for the IoT device performed by the GMLC in the embodiments of the present disclosure, the providing location request sent by the NEF is received, and the positioning sensing message request is sent to the AMF. The positioning sensing message request is configured to request to obtain the location of the IoT device and actual sensing information, such that the actual sensing information is obtained by the GMLC, and based on the comparison result between the actual sensing information and the reference sensing information, the GMLC determines whether to provide the location of the IoT device to the AF, ensuring that the location information of the IoT device is not misused.

Based on the above-mentioned embodiments, in an embodiment, the positioning and sensing method for the IoT device performed by the GMLC includes the following steps S701 to S703.

At step S701, a positioning sensing information response sent by the AMF is received, where the positioning sensing information response includes the location of the IoT device and the actual sensing information.

At step S702, a comparison result between the actual sensing information and the reference sensing information is obtained.

At step S703, a providing location response is sent, based on the comparison result, to the NEF, where in response to the comparison result being consistent, the providing location response includes the location of the IoT device; in response to the comparison result being inconsistent, the providing location response includes a subscription failure message, and the subscription failure message is configured to indicate that subscribing to the location of the IoT device is unsuccessful.

In some embodiments, the positioning sensing information response may be a Namf_Location_ProvidePositioningSensingInfo Response message.

The GMLC in the embodiments of the present disclosure obtains the positioning sensing information response, and compares the actual sensing information included in the positioning sensing information response with the pre-obtained reference sensing information. Specifically, a similarity between the actual sensing information and the reference sensing information may be calculated. If it is determined that the similarity is greater than a preset threshold value, the comparison result is determined to be consistent, and if it is determined that the similarity is not greater than the preset threshold value, the comparison result is determined to be inconsistent. It is also possible to directly compare the actual sensing information and the reference sensing information, and if the actual sensing information and the reference sensing information are completely consistent, the comparison result is determined to be consistent, and if it is determined that the actual sensing information and the reference sensing information are not completely consistent, the comparison result is determined to be inconsistent.

After determining the comparison result, the reference sensing information may be generated, the information content of the reference sensing information is related to the comparison result. When the comparison result is consistent, the providing location response includes the location of the IoT device; when the comparison result is inconsistent, the providing location response includes a subscription failure message, and the subscription failure message is configured to indicate that subscribing to the location of the IoT device is unsuccessful.

In some embodiment, the subscription failure message includes at least one of:
identifier information for indicating that subscribing to the location of the IoT device is unsuccessful; or
a reason for unsuccessfully subscribing to the location of the IoT device.

The subscription failure message may refer to the embodiment corresponding to step S201, and the embodiments of the present disclosure will not be repeated.

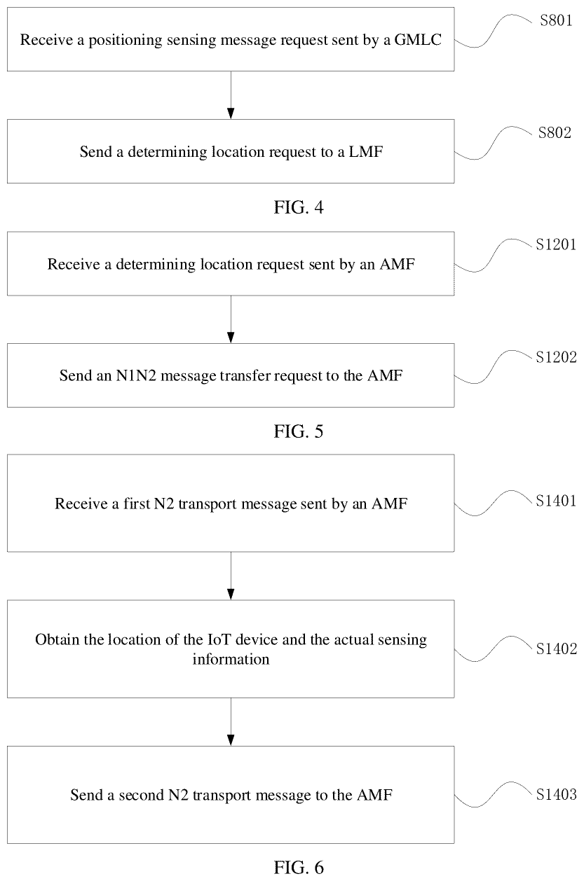

An embodiment of the present disclosure provides a positioning and sensing method for an IoT device, which is performed by an access and mobility management function (AMF), and as shown in FIG. 4, the method includes the following steps S801 to S802.

At step S801, a positioning sensing message request sent by a GMLC is received.

At step S802, a determining location request is sent to a location management function (LMF).

The positioning sensing message request is configured to request to obtain a location of an IoT device and actual sensing information, the actual sensing information is configured to indicate physical information of an actual object collocated with the IoT device, and the positioning sensing message request includes identifier information of the IoT device.

The determining location request is configured to request to obtain the location of the IoT device and the actual sensing information, and the determining location request includes the identifier information of the IoT device.

It will be understood that the LMF is a network element.

In some embodiments, the positioning sensing message request may be a Namf_Location_ProvidePositioningSensingInfo Requeset message.

In some embodiments, the determining location request may be a Nlmf_Location_DetermineLocation Request message.

In some embodiments, before the AMF sends the determining location request to the LMF, the method further includes selecting a suitable LMF based on the local configuration information of the AMF so as to send the determining location request to the suitable LMF. For example, the LMF corresponding to the 5G-access network (5G-AN) of the current serving IoT device, i.e., serves as the suitable LMF. In some embodiments, the AMF may determine the suitable LMF by querying a network repository function (NRF).

In some embodiments, the determining location request may specifically include two sub-requests, i.e., a positioning request and a sensing request. The positioning request is configured to request the location of the IoT device, and the sensing request is configured to request the actual sensing information. The actual sensing information may refer to the embodiment corresponding to step S101, and will not be repeated herein.

Based on the above-mentioned embodiments, in an embodiment, the positioning and sensing method for the IoT device performed by the AMF includes the following steps S901 to S902.

At step S901, a NIN2 message transfer request sent by the LMF is received.

At step S902, a first N2 transport message is sent to a NG-RAN node of the IoT device.

In some embodiments, the NIN2 message transfer request may be a Namf_Communication_NIN2MessageTransfer Service message.

In some embodiments, the first N2 transport message may be an N2 Transport message sent by the AMF to the NG-RAN node via the N2 interface.

In some embodiments, the positioning sensing message request may be a Network Positioning/Sensing message.

The NIN2 message transfer request of the embodiments of the present disclosure is configured to request to obtain the location of the IoT device and the actual sensing information. The NIN2 message request includes the identifier information of the IoT device and the network positioning sensing message to be carried with the location of the IoT device and the actual sensing information, that is, the network positioning sensing message in the NIN2 message request is a null message, which requires the NG-RAN node to write the location of the IoT device and the actual sensing information into the network positioning sensing message and return it after obtaining the location of the IoT device and the actual sensing information.

The first N2 transport message of the embodiments of the present disclosure is configured to request to obtain the location of the IoT device and the actual sensing information, and the first N2 transport message includes the identifier information of the IoT device and the network positioning sensing message to be carried with the location of the IoT device and the actual sensing information.

In an embodiment, the positioning and sensing method for the IoT device performed by the AMF includes the following steps S1001 to S1002.

At step S1001, a second N2 transport message sent by the NG-RAN node is received.

At step S1002, an N2 message notification is sent to the LMF.

In some embodiments, the second N2 transport message may be an N2 Transport message sent by the NG-RAN node to the AMF via the N2 interface.

In some embodiments, the N2 message notification may be a Namf_Communication_N2InfoNotify Service message.

The second N2 transport message of the embodiments of the present disclosure includes a network positioning sensing message carrying the location of the IoT device and the actual sensing information.

The N2 message notification of the embodiments of the present disclosure includes the network positioning sensing message carrying the location of the IoT device and the actual sensing information.

In the embodiments of the present disclosure, the NG-RAN node obtains the location of the IoT device and the actual sensing information, writes the location of the IoT device and the actual sensing information into the network positioning sensing message, and thereafter sends the network positioning sensing message, which carries the location of the IoT device and the actual sensing information, via the second N2 transport message to the AMF. The AMF sends, by means of the N2 message notification, the network positioning sensing message carrying the network positioning sensing message carrying the location of the IoT device and the actual sensing information to the LMF.

Based on the above-mentioned embodiments, in an embodiment, the positioning and sensing method for the IoT device performed by the AMF further includes the following steps S1101 to S1102.

At step S1101, a determining location response sent by the LMF is received.

At step S1102, a positioning sensing information response to the GMLC is sent.

In the embodiments of the present disclosure, the determining location response includes the location of the IoT device and the actual sensing information.

The positioning sensing information response includes the location of the IoT device and the actual sensing information.

In some embodiments, the determining location response may be a Nlmf_Location_DetermineLocation Response message.

In some embodiments, the positioning sensing information response may be a Namf_Location_ProvidePositioningSensingInfo Response message.

An embodiment of the present disclosure provides a positioning and sensing method for an IoT device, which is performed by a LMF, and as shown in FIG. 5, the method includes the following steps S1201 to S1202.

At step S1201, a determining location request sent by an AMF is received.

At step S1202, an NIN2 message transfer request is sent to the AMF.

The determining location request of the embodiments of the present disclosure is configured to request to obtain a location of an IoT device and actual sensing information, the actual sensing information is configured to indicate physical information of an actual object collocated with the IoT device, and the determining location request includes identifier information of the IoT device.

The NIN2 message transfer request includes the identifier information of the IoT device and a network positioning sensing message to be carried with the location of the IoT device and the actual sensing information.

In some embodiments, the determining location request may be a Nlmf_Location_DetermineLocation Request message.

In some embodiments, the NIN2 message transfer request may be a Namf_Communication_NIN2MessageTransfer Service message.

In some embodiments, the network positioning sensing message may be a Network Positioning/Sensing message.

The actual sensing information of the embodiments of the present disclosure may refer to the embodiment corresponding to step S101, which will not be repeated here.

Based on the above-mentioned embodiments, in an embodiment, the positioning and sensing method for the IoT device performed by the LMF includes the following steps S1301 to S1302.

At step S1301, an N2 message notification sent by the AMF is received.

At step S1302, a determining location response is sent to the AMF.

The N2 message notification of the embodiments of the present disclosure includes the network positioning sensing message carrying the location of the IoT device and the actual sensing information.

The determining location response includes the location of the IoT device and the actual sensing information.

In some embodiments, the N2 message notification may be a Namf_Communication_N2InfoNotify Service message.

In some embodiments, the determining location response may be a Nlmf_Location_DetermineLocation Response message.

An embodiment of the present disclosure provides a positioning and sensing method for an IoT device, performed by a next, which is performed by an NG-RAN node. It will be understood that the NG-RAN node is a network element. As shown in FIG. 6, the method includes the following steps S1401 to S1403.

At step S1401, a first N2 transport message sent by an AMF is received.

At step S1402, the location of the IoT device and the actual sensing information are obtained.

At step S1403, a second N2 transport message is sent to the AMF.

In the embodiments of the present disclosure, the actual sensing information is configured to indicate physical information of an actual object collocated with the IoT device, and the first N2 transport message includes identifier information of an IoT device and a network positioning sensing message to be carried with a location of the IoT device and actual sensing information.

The second N2 transport message includes a network positioning sensing message carrying the location of the IoT device and the actual sensing information.

In some embodiments, the first N2 transport message may be an N2 Transport message sent by the AMF to the NG-RAN node via the N2 interface. In the embodiments of the present disclosure, the NG-RAN node obtains the location of the IoT device and the actual sensing information, writes the location of the IoT device and the actual sensing information into the network positioning sensing message, and thereafter sends the network positioning sensing message, which carries the location of the IoT device and the actual sensing information, via the second N2 transport message to the AMF. The AMF sends, by means of the N2 message notification, the network positioning sensing message carrying the network positioning sensing message carrying the location of the IoT device and the actual sensing information to the LMF.

In some embodiments, the second N2 transport message may be an N2 Transport message sent by the NG-RAN node to the AMF via the N2 interface.

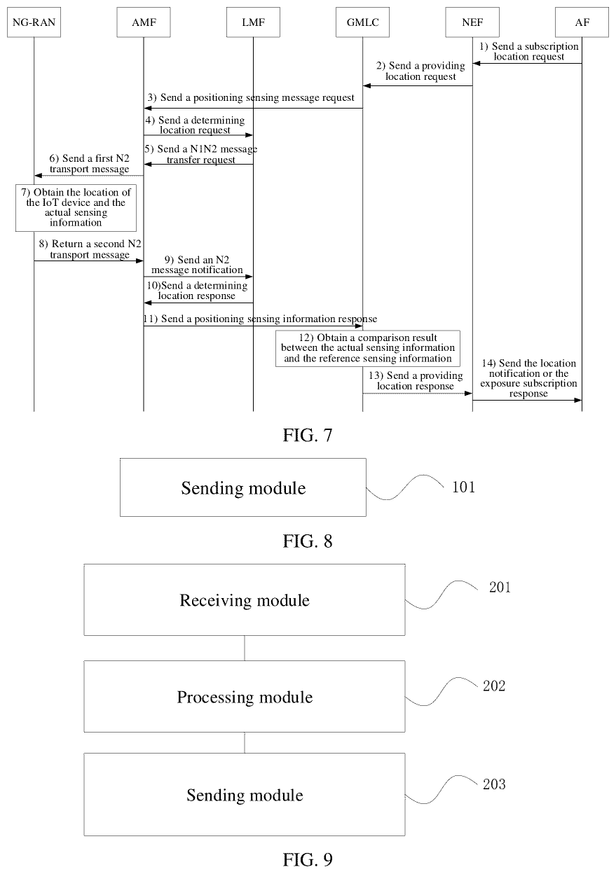

FIG. 7 is a flowchart illustrating a positioning and sensing method for an IoT device according to an embodiment of the present disclosure. As shown in FIG. 7, the method includes the following 1) to 14).
1) The AF sends a subscription location request to the NEF, where the subscription location request is configured to request to subscribe to a location of an IoT device, the subscription location request includes identifier information of the IoT device and reference sensing information, and the reference sensing information is configured to indicate physical information of a reference object collocated with the IoT device.
2) The NEF receives the subscription location request, authorizes the AF to use a location service (LCS), and sends a providing location request to a GMLC, where the providing location request is configured to request to obtain the location of the IoT device, and the providing location request includes the identifier information of the IoT device and the reference sensing information.
3) The GMLC receives the providing location request, and sends a positioning sensing message request to an AMF, where the positioning sensing message request is configured to request to obtain the location of the IoT device and actual sensing information.
4) The AMF receives the positioning sensing message request, and sends a determining location request to an LMF, where the determining location request is configured to request to obtain the location of the IoT device and the actual sensing information, and the determining location request includes the identifier information of the IoT device.
5) The LMF receives the determining location request sent by the AMF, and sends a NIN2 message transfer request to the AMF, where the NIN2 message transfer request is configured to request to obtain the location of the IoT device and the actual sensing information, and the NIN2 message transfer request includes the identifier information of the IoT device and a network positioning sensing message to be carried with the location of the IoT device and the actual sensing information.
6) The AMF receives the NIN2 message transfer request, and sends a first N2 transport message to a NG-RAN node of the IoT device, where the first N2 transport message is configured to request to obtain the location of the IoT device and the actual sensing information, and the first N2 transport message includes the identifier information of the IoT device and the network positioning sensing message to be carried with the location of the IoT device and the actual sensing information.
7) The NG-RAN node receives the first N2 transport message to obtain the location of the IoT device and the actual sensing information.
8) The NG-RAN node sends a second N2 transport message to the AMF, where the second N2 transport message includes a network positioning sensing message carrying the location of the IoT device and the actual sensing information.
9) The AMF receives the second N2 transport message, and sends an N2 message notification to the LMF, where the N2 message notification includes the network positioning sensing message carrying the location of the IoT device and the actual sensing information.
10) The LMF receives the N2 message notification, and sends a determining location response to the AMF, where the determining location response includes the location of the IoT device and the actual sensing information.
11) The AMF receives the determining location response sent by the LMF, and sends a positioning sensing information response to the GMLC, where the positioning sensing information response includes the location of the IoT device and the actual sensing information.
12) The GMLC receives the positioning sensing information response, and obtains a comparison result between the actual sensing information and the reference sensing information.
13) The GMLC sends, based on the comparison result, a providing location response to the NEF; where in response to the comparison result being consistent, the providing location response includes the location of the IoT device; in response to the comparison result being inconsistent, the providing location response includes a subscription failure message, and the subscription failure message is configured to indicate that subscribing to the location of the IoT device is unsuccessful.
14) The NEF receives a providing location response; and in response to determining that the providing location response includes the location of the IoT device, sending, by the NEF, a location notification to the AF, where the location notification includes the location of the IoT device; in response to determining that the positioning location response includes a subscription failure message, sending, by the NEF, an exposure subscription response to the AF, where the exposure subscription response includes the subscription failure message; and accordingly, the AF obtains the location notification or the exposure subscription response.

An embodiment of the present disclosure provides an AF, and as shown in FIG. 8, the AF may include a sending module 101.

The sending module 101 is configured to send a subscription location request, where the subscription location request is configured to request to subscribe to a location of an IoT device.

The subscription location request includes identifier information of the IoT device and reference sensing information, and the reference sensing information is configured to indicate physical information of a reference object collocated with the IoT device.

The AF of the embodiments of the present disclosure may perform the positioning and sensing method for the IoT device performed by the AF provided in the method embodiments of the present disclosure, which are similarly implemented. The operations performed by the modules in the device embodiments of the present disclosure correspond to the steps in the positioning and sensing method for the IoT device performed by the AF of the method embodiments of the present disclosure. The details of functions of the modules of the AF can be found in the descriptions of the corresponding method shown in the method embodiments and will not be repeated here.

An embodiment of the present disclosure provides a NEF, and as shown in FIG. 9, the NEF may include: a receiving module 201, a processing module 202, and a sending module 203.

The receiving module 201 is configured to receive a subscription location request sent by an application function (AF), where the subscription location request is configured to indicate that a location of an IoT device is subscribed to, the subscription location request includes identifier information of the IoT device and reference sensing information, and the reference sensing information is configured to indicate physical information of a reference object collocated with the IoT device.

The processing module 202 is configured to authorize the AF to use a location service (LCS).

The sending module 203 is configured to send a providing location request to a gateway mobile location center (GMLC), where the providing location request is configured to request to obtain the location of the IoT device, and the providing location request includes the identifier information of the IoT device and the reference sensing information.

The NEF of the embodiments of the present disclosure may perform the positioning and sensing method for the IoT device performed by the NEF provided in the method embodiments of the present disclosure, which are similarly implemented. The operations performed by the modules in the device embodiments of the present disclosure correspond to the steps in the positioning and sensing method for the IoT device performed by the NEF of the method embodiments of the present disclosure. The details of functions of the modules of the NEF can be found in the descriptions of the corresponding method shown in the method embodiments and will not be repeated here.

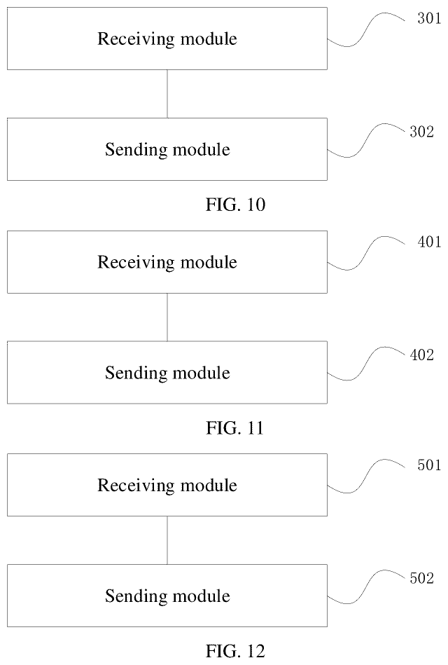

An embodiment of the present disclosure provides a GMLC, and as shown in FIG. 10, the GMLC may include: a receiving module 301, and a sending module 302.

The receiving module 301 is configured to receive a providing location request sent by a network exposure function (NEF), where the providing location request is configured to request to obtain a location of an IoT device, the providing location request includes identifier information of the IoT device and reference sensing information, and the reference sensing information is configured to indicate physical information of a reference object collocated with the IoT device.

The sending module 302 is configured to send a positioning sensing message request to an access and mobility management function (AMF), where the positioning sensing message request is configured to request to obtain a location of an IoT device and actual sensing information, the actual sensing information is configured to indicate physical information of an actual object collocated with the IoT device, and the positioning sensing message request includes identifier information of the IoT device.

The GMLC of the embodiments of the present disclosure may perform the positioning and sensing method for the IoT device performed by the GMLC provided in the method embodiments of the present disclosure, which are similarly implemented. The operations performed by the modules in the device embodiments of the present disclosure correspond to the steps in the positioning and sensing method for the IoT device performed by the GMLC of the method embodiments of the present disclosure. The details of functions of the modules of the GMLC can be found in the descriptions of the corresponding method shown in the method embodiments and will not be repeated here.

An embodiment of the present disclosure provides an AMF, and as shown in FIG. 11, the AMF may include: a receiving module 401, and a sending module 402.

The receiving module 401 is configured to receive a positioning sensing message request sent by a gateway mobile location center (GMLC), where the positioning sensing message request is configured to request to obtain a location of an IoT device and actual sensing information, the actual sensing information is configured to indicate physical information of an actual object collocated with the IoT device, and the positioning sensing message request includes identifier information of the IoT device.

The sending module 402 is configured to send a determining location request to a location management function (LMF), where the determining location request is configured to request to obtain the location of the IoT device and the actual sensing information, and the determining location request includes the identifier information of the IoT device.

The AMF of the embodiments of the present disclosure may perform the positioning and sensing method for the IoT device performed by the AMF provided in the method embodiments of the present disclosure, which are similarly implemented. The operations performed by the modules in the device embodiments of the present disclosure correspond to the steps in the positioning and sensing method for the IoT device performed by the AMF of the method embodiments of the present disclosure. The details of functions of the modules of the AMF can be found in the descriptions of the corresponding method shown in the method embodiments and will not be repeated here.

An embodiment of the present disclosure provides a LMF, and as shown in FIG. 12, the LMF may include: a receiving module 501, and a sending module 502.

The receiving module 501 is configured to receive a determining location request sent by an access and mobility management function (AMF), where the determining location request is configured to request to obtain a location of an IoT device and actual sensing information, the actual sensing information is configured to indicate physical information of an actual object collocated with the IoT device, and the determining location request includes identifier information of the IoT device.

The sending module 502 is configured to send an NIN2 message transfer request to the AMF, where the NIN2 message transfer request includes the identifier information of the IoT device and a network positioning sensing message to be carried with the location of the IoT device and the actual sensing information.

The LMF of the embodiments of the present disclosure may perform the positioning and sensing method for the IoT device performed by the LMF provided in the method embodiments of the present disclosure, which are similarly implemented. The operations performed by the modules in the device embodiments of the present disclosure correspond to the steps in the positioning and sensing method for the IoT device performed by the LMF of the method embodiments of the present disclosure. The details of functions of the modules of the LMF can be found in the descriptions of the corresponding method shown in the method embodiments and will not be repeated here.

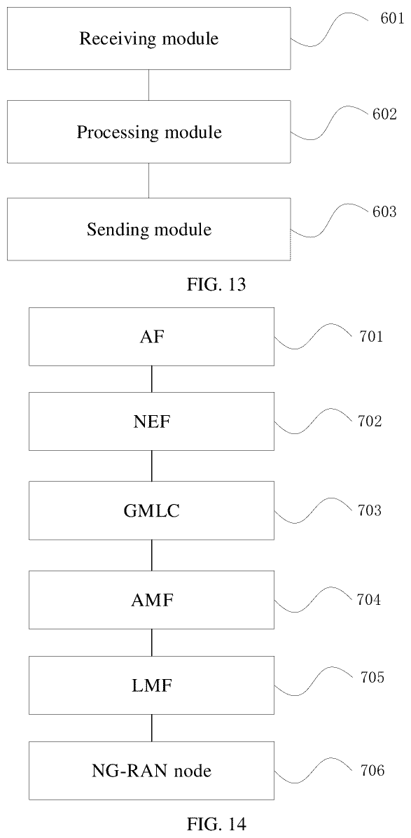

An embodiment of the present disclosure provides an NG-RAN node, and as shown in FIG. 13, the NG-RAN node may include: a receiving module 601, a processing module 602, and a sending module 603.

The receiving module 601 is configured to receive a first N2 transport message sent by an access and mobility management function (AMF), where the first N2 transport message includes identifier information of an IoT device and a network positioning sensing message to be carried with a location of the IoT device and actual sensing information.

The processing module 602 is configured to obtain the location of the IoT device and the actual sensing information, where the actual sensing information is configured to indicate physical information of an actual object collocated with the IoT device.

The sending module 603 is configured to send a second N2 transport message to the AMF, where the second N2 transport message includes a network positioning sensing message carrying the location of the IoT device and the actual sensing information.

The NG-RAN node of the embodiments of the present disclosure may perform the positioning and sensing method for the IoT device performed by the NG-RAN node provided in the method embodiments of the present disclosure, which are similarly implemented. The operations performed by the modules in the device embodiments of the present disclosure correspond to the steps in the positioning and sensing method for the IoT device performed by the NG-RAN node of the method embodiments of the present disclosure. The details of functions of the modules of the NG-RAN node can be found in the descriptions of the corresponding method shown in the method embodiments and will not be repeated here.

An embodiment of the present disclosure provides a positioning and sensing system for an IoT device, and as shown in FIG. 14, the system includes at least one of:
an application function (AF) 701;
a network exposure function (NEF) 702;
a gateway mobile location center (GMLC) 703;
an access and mobility management function (AMF) 704;
a location management function (LMF) 705; or
a next generation radio access network (NG-RAN) node 706.

An embodiment of the present disclosure provides an electronic device, including: a processor; and a memory storing computer programs executable by the processor; where the computer programs, when executed by the processor, cause the processor to perform the positioning and sensing method for the IoT device. The embodiments of the present disclosure may effectively avoid the defect in the prior art caused by the inability to effectively determine whether the location of an actual object collocated with the IoT device is unreasonably provided when the location of the IoT device is provided due to the fact that only the identifier information of the IoT device is provided at the time of requesting a subscription to the IoT device, so as to ensure that the location information of the IoT device is not misused.

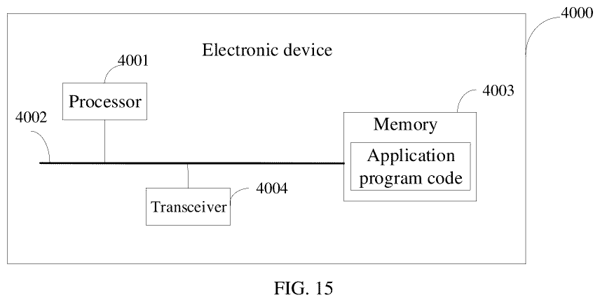

The embodiments of the present disclosure also provide an electronic device, as shown in FIG. 15, the electronic device 4000 may include: a processor 4001 and a memory 4003. The processor 4001 and the memory 4003 are connected, e.g., via a bus 4002. In an embodiment, the electronic device 4000 may also include a transceiver 4004, and the transceiver 4004 may be used for data interaction between the electronic device and other electronic devices, such as sending of data and/or receiving of data. It will be noted that the transceiver 4004 is not limited to one in number in practical applications, and the structure of the electronic device 4000 does not constitute a limitation of the embodiments of the present disclosure.

The processor 4001 may be a central processing unit (CPU), a general purpose processor, a digital signal processor (DSP), an application specific integrated circuit (ASIC), a field programmable gate array (FPGA) or other programmable logic device, a transistor logic device, a hardware component or any combination thereof. It can implement or execute various exemplary logical blocks, modules, and circuits described in conjunction with the present disclosure. The processor 4001 may also be a combination for realizing computing functions, for example, including a combination of one or more microprocessor, a combination of digital signal processor (DSP) and microprocessor, etc.

The bus 4002 may include a pathway to transfer information between the foregoing components. The bus 4002 may be a peripheral component interconnect (PCI) bus or an extended industry standard architecture (EISA) bus, and so on. The bus 4002 may include an address bus, a data bus, a control bus, and so on. For ease of representation, only a thick line is shown in FIG. 15, but it does not mean that there is only one bus or one type of bus.

The memory 4003 may be a read only memory (ROM) or other type of static storage device that can store static information and instructions, a random access memory (RAM) or other type of dynamic storage device that can store information and instructions. It can also be an electrically erasable programmable read only memory (EEPROM), a compact disc read only memory (CD-ROM), CD-ROM) or other optical storage (including a compact disc, a laser disc, an optical disc, a digital versatile disc, a Blu-ray disc, etc.), magnetic storage medium or other magnetic storage devices, or any other medium that can be used to carry or store desired program codes in the form of instructions or data structures and can be accessed by a computer, but is not limited thereto.

The memory 4003 is configured to store the computer programs for executing the scheme of the present disclosure and is controlled for execution by processor 4001. The processor 4001 is configured to execute the computer programs stored in the memory 4003 to implement the foregoing method embodiments.

The embodiments of the present disclosure further provide a computer-readable storage medium, storing computer programs thereon, where the computer programs, when executed by a processor, cause the processor to perform any of the methods in the embodiments of the present disclosure.

The present disclosure also provides a computer program product including computer programs, where the computer programs, when executed by a processor, realizes the functions of any of the method embodiments.

The technical solution provided by the embodiments of the present disclosure may include the following beneficial effects.

The subscription location request includes not only the identifier information of the IoT device, but also the reference sensing information. The reference sensing information is configured to indicate the physical information of the reference object collocated with the IoT device, which is equivalent to establishing the correspondence between the IoT device and the reference object. Subsequently, when obtaining the location of the IoT device, it will be determined whether the reference object and the actual object are the same by comparing whether the actual sensing information is identical to the reference sensing information, and thus determine whether the location of the IoT device can be provided to the AF. The embodiments of the present disclosure may effectively avoid the defect in the prior art caused by the inability to effectively determine whether the location of an actual object collocated with the IoT device is unreasonably provided when the location of the IoT device is provided due to the fact that only the identifier information of the IoT device is provided at the time of requesting a subscription to the IoT device, so as to ensure that the location information of the IoT device is not misused.

The terms “first,” “second,” “third,” “fourth,” “1,” “2,” etc. (if any) in the description embodiments and claims of the present disclosure and the above drawings are used to distinguish similar objects, and are not used to describe a particular order or sequence. It should be understood that the data used in this way may be interchanged as appropriate, so that the examples of the present application described herein can be implemented, for example, in a sequence other than those illustrated herein.

It will be understood that while the flowcharts of the embodiments of the present disclosure indicate individual operation steps by means of arrows, the order in which these steps are implemented is not limited to the order indicated by the arrows. Unless explicitly stated herein, in some implementation scenarios of the embodiments of the present disclosure, the implementation steps in the respective flowcharts may be performed in other orders as desired. In addition, some or all of the steps in the respective flowcharts may include multiple sub-steps or multiple phases based on actual implementation scenarios. Some or all of these sub-steps or phases may be performed at the same moment, and each of these sub-steps or phases may be performed separately at different moments. In different scenarios, the performance order of these sub-steps or phases can be flexibly configured according to requirements, and the embodiments of the present disclosure are not limited thereto.

It will be noted that, for those skilled in the art, other similar means of implementation based on the technical concept of the present disclosure, without departing from the technical concept of the solution of the present disclosure, also fall within the scope of the embodiments of the present disclosure.

1. A positioning and sensing method for an internet of things (IoT) device, and comprising:
sending, by an application function (AF), a subscription location request to a network exposure function (NEF), wherein the subscription location request is configured to request to subscribe to a location of an IoT device;
wherein the subscription location request comprises identifier information of the IoT device and reference sensing information, and the reference sensing information is configured to indicate physical information of a reference object collocated with the IoT device.

2. The method of claim 1, further comprising, after sending the subscription location request:
obtaining, by the AF, a location notification or an exposure subscription response sent by the NEF;
wherein the location notification comprises the location of the IoT device; the exposure subscription response comprises a subscription failure message, and the subscription failure message is configured to indicate that subscribing to the location of the IoT device is unsuccessful.

3. The method of claim 2, wherein the subscription failure message comprises at least one of:
identifier information for indicating that subscribing to the location of the IoT device is unsuccessful; or
a reason for unsuccessfully subscribing to the location of the IoT device.

4. The method of claim 1, further comprising:
receiving, by the NEF, the subscription location request sent by the AF;
authorizing, by the NEF, the AF to use a location service (LCS); and
sending, by the NEF, a providing location request to a gateway mobile location center (GMLC), wherein the providing location request is configured to request to obtain the location of the IoT device, and the providing location request comprises the identifier information of the IoT device and the reference sensing information.

5. The method of claim 4, further comprising:
receiving, by the NEF, a providing location response sent by the GMLC, determining that the providing location response comprises the location of the IoT device, and sending a location notification to the AF, wherein the location notification comprises the location of the IoT device.

6. The method of claim 4, further comprising:
receiving, by the NEF, a providing location response sent by the GMLC, and determining that the positioning location response comprises a subscription failure message, wherein the subscription failure message is configured to indicate that subscribing to the location of the IoT device is unsuccessful; and sending an exposure subscription response to the AF, wherein the exposure subscription response comprises the subscription failure message.

7. (canceled)

8. The method of claim 1, further comprising:
receiving, by a gateway mobile location center (GMLC), a providing location request sent by the NEF, wherein the providing location request is configured to request to obtain a location of an IoT device, the providing location request comprises identifier information of the IoT device and reference sensing information, and the reference sensing information is configured to indicate physical information of a reference object collocated with the IoT device; and
sending, by the GMLC, a positioning sensing message request to an access and mobility management function (AMF), wherein the positioning sensing message request is configured to request to obtain the location of the IoT device and actual sensing information, the actual sensing information is configured to indicate physical information of an actual object collocated with the IoT device, and the positioning sensing message request comprises the identifier information of the IoT device.

9. The method according to claim 8, further comprising:
receiving, by the GMLC, a positioning sensing information response sent by the AMF, wherein the positioning sensing information response comprises the location of the IoT device and the actual sensing information;
obtaining, by the GMLC, a comparison result between the actual sensing information and the reference sensing information; and
sending, by the GMLC based on the comparison result, a providing location response to the NEF, wherein
in response to the comparison result being consistent, the providing location response comprises the location of the IoT device;
in response to the comparison result being inconsistent, the providing location response comprises a subscription failure message, and the subscription failure message is configured to indicate that subscribing to the location of the IoT device is unsuccessful.

10. (canceled)

11. The method of claim 1, further comprising:
receiving, by an access and mobility management function (AMF), a positioning sensing message request sent by a gateway mobile location center (GMLC), wherein the positioning sensing message request is configured to request to obtain a location of an IoT device and actual sensing information, the actual sensing information is configured to indicate physical information of an actual object collocated with the IoT device, and the positioning sensing message request comprises identifier information of the IoT device; and
sending, by the AMF, a determining location request to a location management function (LMF), wherein the determining location request is configured to request to obtain the location of the IoT device and the actual sensing information, and the determining location request comprises the identifier information of the IoT device.

12. The method of claim 11, further comprising:
receiving, by the AMF, a N1N2 message transfer request sent by the LMF, wherein the N1N2 message transfer request is configured to request to obtain the location of the IoT device and the actual sensing information, and the N1N2 message transfer request comprises the identifier information of the IoT device and a network positioning sensing message to be carried with the location of the IoT device and the actual sensing information; and
sending, by the AMF, a first N2 transport message to a next generation radio access network (NG-RAN) node of the IoT device, wherein the first N2 transport message is configured to request to obtain the location of the IoT device and the actual sensing information, and the first N2 transport message comprises the identifier information of the IoT device and the network positioning sensing message to be carried with the location of the IoT device and the actual sensing information.

13. The method according to claim 11, further comprising:
receiving, by the AMF, a second N2 transport message sent by the NG-RAN node, wherein the second N2 transport message comprises a network positioning sensing message carrying the location of the IoT device and the actual sensing information; and
sending, by the AMF, an N2 message notification to the LMF, wherein the N2 message notification comprises the network positioning sensing message carrying the location of the IoT device and the actual sensing information.

14. The method of claim 11, further comprising:
receiving, by the AMF, a determining location response sent by the LMF, wherein the determining location response comprises the location of the IoT device and the actual sensing information; and
sending, by the AMF, a positioning sensing information response to the GMLC, wherein the positioning sensing information response comprises the location of the IoT device and the actual sensing information.

15. The method of claim 1, further comprising:
receiving, by a location management function (LMF), a determining location request sent by an access and mobility management function (AMF), wherein the determining location request is configured to request to obtain a location of an IoT device and actual sensing information, the actual sensing information is configured to indicate physical information of an actual object collocated with the IoT device, and the determining location request comprises identifier information of the IoT device; and
sending, by the LMF, an N1N2 message transfer request to the AMF, wherein the N1N2 message transfer request comprises the identifier information of the IoT device and a network positioning sensing message to be carried with the location of the IoT device and the actual sensing information.

16. The method of claim 15, further comprising:
receiving, by the LMF, an N2 message notification sent by the AMF, wherein the N2 message notification comprises the network positioning sensing message carrying the location of the IoT device and the actual sensing information; and
sending, by the LMF, a determining location response to the AMF, wherein the determining location response comprises the location of the IoT device and the actual sensing information.

17. The method of claim 1, further comprising:
receiving, by a next generation radio access network (NG-RAN) node, a first N2 transport message sent by an access and mobility management function (AMF), wherein the first N2 transport message comprises identifier information of an IoT device and a network positioning sensing message to be carried with a location of the IoT device and actual sensing information;
obtaining, by the NG-RAN node, the location of the IoT device and the actual sensing information, wherein the actual sensing information is configured to indicate physical information of an actual object collocated with the IoT device; and
sending, by the NG-RAN node, a second N2 transport message to the AMF, wherein the second N2 transport message comprises a network positioning sensing message carrying the location of the IoT device and the actual sensing information.

18. A positioning and sensing method for an internet of things (IoT) device, comprising:
sending, by an application function (AF), a subscription location request to a network exposure function (NEF), wherein the subscription location request is configured to request to subscribe to a location of an IoT device, the subscription location request comprises identifier information of the IoT device and reference sensing information, and the reference sensing information is configured to indicate physical information of a reference object collocated with the IoT device;
receiving, by the NEF, the subscription location request, authorizing, by the NEF, the AF to use a location service (LCS), and sending, by the NEF, a providing location request to a gateway mobile location center (GMLC), wherein the providing location request is configured to request to obtain the location of the IoT device, and the providing location request comprises the identifier information of the IoT device and the reference sensing information;
receiving, by the GMLC, the providing location request, and sending, by the GMLC, a positioning sensing message request to an access and mobility management function (AMF), wherein the positioning sensing message request is configured to request to obtain the location of the IoT device and actual sensing information;
receiving, by AMF, the positioning sensing message request, and sending, by AMF, a determining location request to a location management function (LMF), wherein the determining location request is configured to request to obtain the location of the IoT device and the actual sensing information, and the determining location request comprises the identifier information of the IoT device;
receiving, by the LMF, the determining location request, and sending, by the LMF, a N1N2 message transfer request to the AMF, wherein the N1N2 message transfer request is configured to request to obtain the location of the IoT device and the actual sensing information, and the N1N2 message transfer request comprises the identifier information of the IoT device and a network positioning sensing message to be carried with the location of the IoT device and the actual sensing information;
receiving, by the AMF, the N1N2 message transfer request, and sending, by the AMF, a first N2 transport message to a next generation radio access network (NG-RAN) node of the IoT device, wherein the first N2 transport message is configured to request to obtain the location of the IoT device and the actual sensing information, and the first N2 transport message comprises the identifier information of the IoT device and the network positioning sensing message to be carried with the location of the IoT device and the actual sensing information;
receiving, by the NG-RAN node, the first N2 transport message, obtaining, by the NG-RAN node, the location of the IoT device and the actual sensing information, and sending, by the NG-RAN node, a second N2 transport message to the AMF, wherein the second N2 transport message comprises a network positioning sensing message carrying the location of the IoT device and the actual sensing information;
receiving, by the AMF, the second N2 transport message, and sending, by the AMF, an N2 message notification to the LMF, wherein the N2 message notification comprises the network positioning sensing message carrying the location of the IoT device and the actual sensing information;
receiving, by the LMF, the N2 message notification, and sending, by the LMF, a determining location response to the AMF, wherein the determining location response comprises the location of the IoT device and the actual sensing information;
receiving, by the AMF, the determining location response, and sending, by the AMF, a positioning sensing information response to the GMLC, wherein the positioning sensing information response comprises the location of the IoT device and the actual sensing information;
receiving, by the GMLC, the positioning sensing information response, obtaining, by the GMLC, a comparison result between the actual sensing information and the reference sensing information, and sending, by the GMLC based on the comparison result, a providing location response to the NEF; wherein in response to the comparison result being consistent, the providing location response comprises the location of the IoT device; in response to the comparison result being inconsistent, the providing location response comprises a subscription failure message, and the subscription failure message is configured to indicate that subscribing to the location of the IoT device is unsuccessful;
receiving, by the NEF, a providing location response; and in response to determining that the providing location response comprises the location of the IoT device, sending, by the NEF, a location notification to the AF, wherein the location notification comprises the location of the IoT device; in response to determining that the positioning location response comprises a subscription failure message, sending, by the NEF, an exposure subscription response to the AF, wherein the exposure subscription response comprises the subscription failure message; and
obtaining, by the AF, the location notification or the exposure subscription response.

19.-24. (canceled)

25. A positioning and sensing system for an internet of things (IoT), comprising at least one of:
an application function (AF);
a network exposure function (NEF);
a gateway mobile location center (GMLC);
an access and mobility management function (AMF);
a location management function (LMF); or
a next generation radio access network (NG-RAN) node.

26. (canceled)

27. (canceled)

28. The system of claim 25,
wherein the AF is configured to:
send a subscription location request to the NEF, wherein the subscription location request is configured to request to subscribe to a location of an IoT device; wherein the subscription location request comprises identifier information of the IoT device and reference sensing information, and the reference sensing information is configured to indicate physical information of a reference object collocated with the IoT device;
wherein the NEF is configured to:
receive the subscription location request sent by the AF;
authorize the AF to use the LCS; and
send a providing location request to the GMLC,
wherein the providing location request is configured to request to obtain the location of the IoT device, and the providing location request comprises the identifier information of the IoT device and the reference sensing information.

29. The system of claim 25,
wherein the GMLC is configured to:
receive a providing location request sent by the NEF, wherein the providing location request is configured to request to obtain a location of an IoT device, the providing location request comprises identifier information of the IoT device and reference sensing information, and the reference sensing information is configured to indicate physical information of a reference object collocated with the IoT device; and
send a positioning sensing message request to the AMF, wherein the positioning sensing message request is configured to request to obtain the location of the IoT device and actual sensing information, the actual sensing information is configured to indicate physical information of an actual object collocated with the IoT device, and the positioning sensing message request comprises the identifier information of the IoT device;
wherein the AMF is configured to:
receive a positioning sensing message request sent by the GMLC, wherein the positioning sensing message request is configured to request to obtain a location of an IoT device and actual sensing information, the actual sensing information is configured to indicate physical information of an actual object collocated with the IoT device, and the positioning sensing message request comprises identifier information of the IoT device; and
send a determining location request to the LMF, wherein the determining location request is configured to request to obtain the location of the IoT device and the actual sensing information, and the determining location request comprises the identifier information of the IoT device.

30. The system of claim 25,
wherein the LMF is configured to:
receive a determining location request sent by the AMF, wherein the determining location request is configured to request to obtain a location of an IoT device and actual sensing information, the actual sensing information is configured to indicate physical information of an actual object collocated with the IoT device, and the determining location request comprises identifier information of the IoT device; and
send an N1N2 message transfer request to the AMF, wherein the N1N2 message transfer request comprises the identifier information of the IoT device and a network positioning sensing message to be carried with the location of the IoT device and the actual sensing information;
wherein the NG-RAN node is configured to:
receive a first N2 transport message sent by the AMF, wherein the first N2 transport message comprises identifier information of an IoT device and a network positioning sensing message to be carried with a location of the IoT device and actual sensing information;
obtain the location of the IoT device and the actual sensing information, wherein the actual sensing information is configured to indicate physical information of an actual object collocated with the IoT device; and
send a second N2 transport message to the AMF, wherein the second N2 transport message comprises a network positioning sensing message carrying the location of the IoT device and the actual sensing information.
